(19) United States
(12) Patent Application Publication
(10) Pub. No.: US 2002/0059414 A1
(43) Pub. Date: May 16, 2002

(54) Data mirroring restoration in a distributed system

(75) Inventors: Igor Katz, Rosh HaAyin (IL); Alexander Kharif, Netanya (IL); Alexander Vainshtein, Lod (IL); Alexander Shimelmits, Rishon Lezion (IL)

Correspondence Address: BROWDY AND NEIMARK, P.L.L.C., 624 NINTH STREET, NW, SUITE 300, WASHINGTON, DC, 20001-5303, US

(73) Assignee: Lightscape Networks Ltd., Petach Tikva (IL)

(21) Appl. No.: 09/987,104

(22) Filed: Nov. 13, 2001

(30) Foreign Application Priority Data
Nov. 12, 2000 (IL) 139628

(51) Int. Cl. G06F 15/173

(52) U.S. Cl. 709/223; 709/226

(57) ABSTRACT

A method for use in a distributed system that includes a server managing a master volume of data including a plurality of static attributes and at least one dynamic attribute whose prevailing values in the master volume of data are respectively updated and not updated as a consequence of a command from a client, and at least two clients each managing a volume of data intended to mirror the master volume of data. The method provided, enables data mirroring restoration at a client freshly reconnected to the server after a communication downtime period.

### FIELD OF THE INVENTION

The invention is in the field of data mirroring restoration in a distributed system in general, and in a telecommunication network management system in particular.

### BACKGROUND OF THE INVENTION

Telecommunication network management systems are distributed systems including one or more management layers of client/server architectures in which a server manages a master volume of data containing a multitude of data objects each including one or more attributes each having a prevailing value, and its clients each manage a volume of data mirroring the master volume of data. A temporary communication downtime between a server and a client can potentially lead to a discrepancy between the client's volume of data and the master volume of data on its reconnection to the server. In the affirmative, this necessitates that the freshly reconnected client's volume of data be resynchronized to the master volume of data prior to resumption of full service.

One approach for data mirroring restoration at a freshly reconnected client involves an automatic complete upload of the prevailing values of all the attributes of all the data objects from the master volume of data to the client's volume of data on its reconnection to the server. This approach affords complete data mirroring consistency at a freshly reconnected client, however, it is relatively slow since it effectively requires the reformatting of a freshly reconnected client's volume of data.

Another approach also affording complete data mirroring consistency at a freshly reconnected client is based on the discrimination of those data objects updated during a communication downtime period Tₑ−Tₛ where Tₑ is the end of the communication downtime period and Tₛ is the start of the communication downtime period. This approach is enabled by the server managing a data structure listing a time signature in respect of each and every data object in its master volume of data specifying the time of the last occurrence of an alteration of the prevailing value of one of its attributes. This approach is again relatively slow since it requires a decision to be made in respect of each and every data object in the master volume of data, and moreover, the additional data structure imposes additional storage requirements at the server which is a scarce resource.

### SUMMARY OF THE INVENTION

In accordance with the present invention, there is provided for use in a distributed system including a server managing a master volume of data including a plurality of at least one static attribute and at least one dynamic attribute whose prevailing values in the master volume of data are respectively updated and not updated as a consequence of a command from a client, and at least two clients C1 and C2 each managing a volume of data intended to mirror the master volume of data, a method for data mirroring restoration at a client freshly reconnected to the server after a communication downtime period, the method comprising the steps of:

(One) storing prevailing values of dynamic attributes of the master volume of data in temporary storage at the server;

(Two) storing prevailing values of static attributes of the master volume of data in persistent storage at the server;

(Three) providing the server with a master synchronization counter V_{S} incremented by the updating of the prevailing values of one or more static attributes in the master volume of data as a consequence of a command from a first client C1 of the at least two clients;

(Four) providing each client with a synchronization counter V_{C}, the synchronization counter V_{C2} of a second client C2 of the at least two clients only being synchronized with the master synchronization counter VS on the successful uploading of the prevailing values of the static attributes updated in the master volume of data as a consequence of the command from the first client C1 whereby its volume of data mirrors the master volume of data; and

(Five) uploading from the master volume of data to the freshly reconnected client's volume of data, the prevailing values of all its dynamic attributes and, in the case that its synchronization counter V_{C2}<V_{S}, the prevailing values of at least all of its static attributes whose prevailing values were updated during the communication downtime period, otherwise in the case that V_{S}=V_{C2} taking no data mirroring restoration action in respect of the static attributes.

The present invention is based on the notion that by classifying the attributes stored in a server's master volume of data into two different types, thereby enabling different uploading strategies, data mirroring restoration can be expedited without the downside of excessive storage requirements, excessive computational loads, and the like. The present invention is particularly suitable for data mirroring restoration in telecommunication network management systems since they typically include thousands of data objects, and many thousands of attributes.

### BRIEF DESCRIPTION OF THE DRAWINGS

In order to understand the invention and to see how it can be carried out in practice, preferred embodiments will now be described, by way of a non-limiting examples only, with reference to the accompanying drawings, in which similar parts are likewise numbered, and in which:

FIG. 1 is a schematic representation of a telecommunication network management system constructed and operative in accordance with the present invention;

FIGS. 2A and 2B are schematic representations showing the management of a transaction log kept by a server of the telecommunication network management system of FIG. 1;

FIGS. 3A and 3B are a flow diagram of the uploading of the prevailing values of static attributes from a server's master volume of data to a freshly reconnected client's volume of data in accordance with the data mirroring restoration method of the present invention; and

FIG. 4 is a flow diagram of a degenerate version of the data mirroring restoration method of FIGS. 3A and 3B.

### DETAILED DESCRIPTION OF THE DRAWINGS

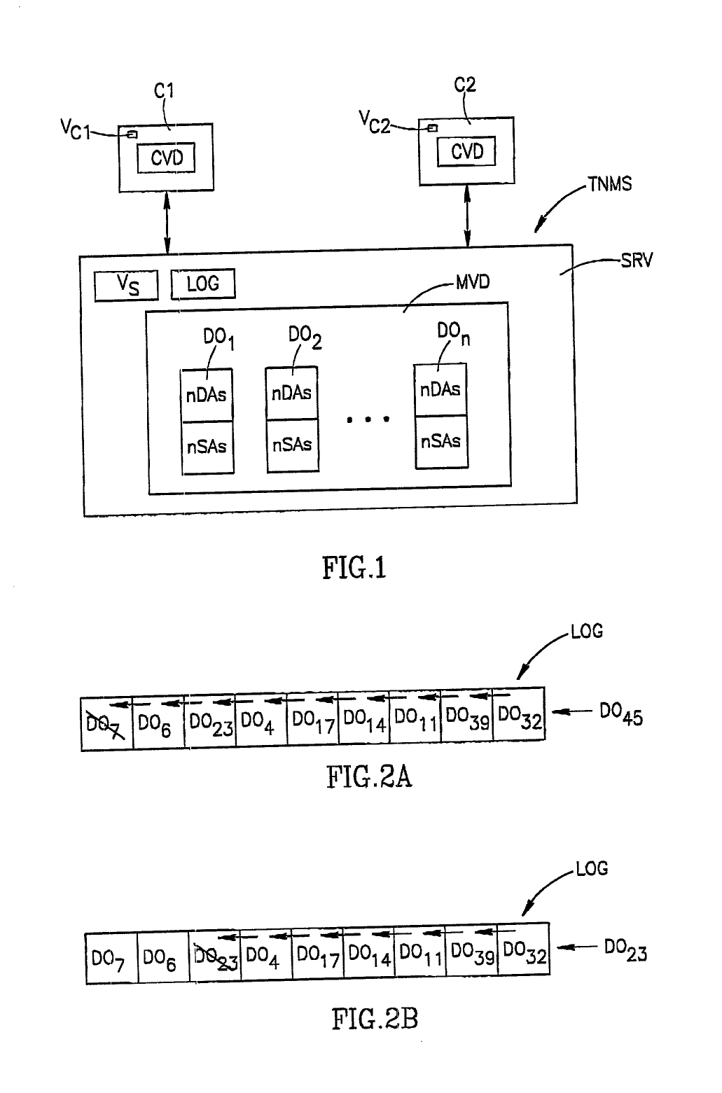

FIG. 1 shows a Telecommunication Network Management System denoted TNMS including two Element Management System (EMS) workstations (constituting two clients denoted C1 and C2) connected to a Network Element (NE) workstation (constituting a server denoted SRV).

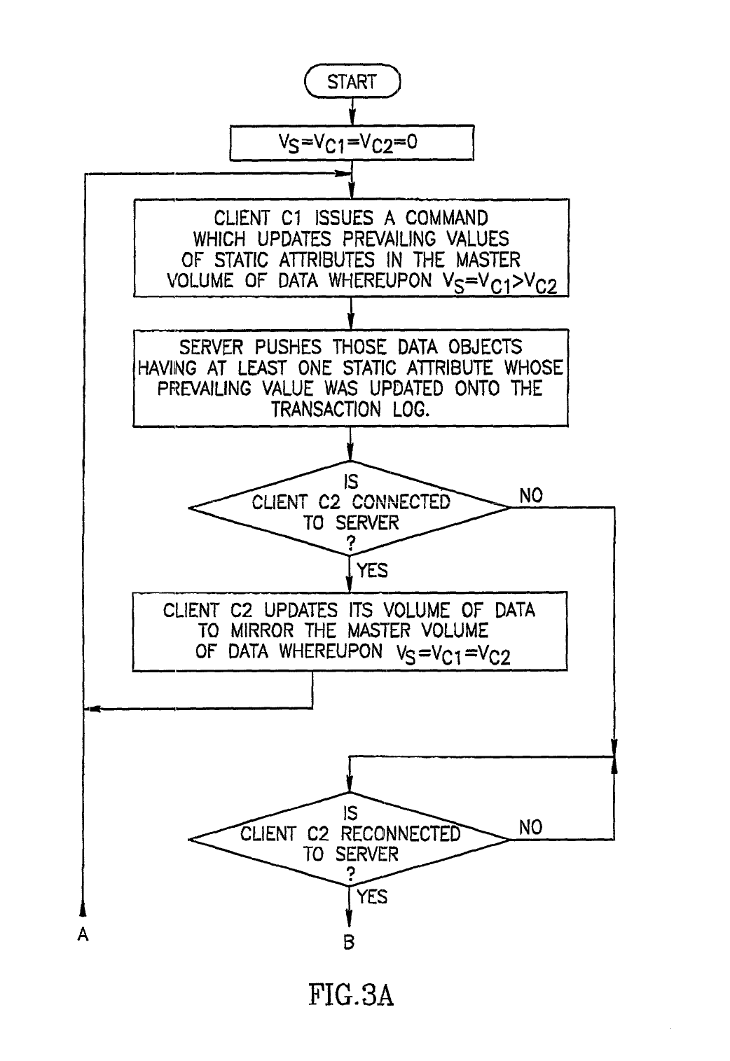

The NE workstation manages a master volume of data denoted MVD including a total of n data objects DO₁, DO₂, . . . , DOₙ each including a total of n dynamic attributes DA₁, DA₂, . . . , DAₙ and a total of n static attributes SA₁, SA₂, . . . , SAₙ. The prevailing values of the dynamic attributes are stored in temporary storage, and are not updated as a consequence of a command from one of the clients. The prevailing values of the static attributes are stored in persistent storage, and are updated as a consequence of a command from one of the clients. The NE workstation keeps a master synchronization counter V_{S} which is incremented on each occurrence of the updating of one or more static attributes of a data object. The NE workstation keeps a stack-like transaction log denoted LOG for storing up to N data object identifiers on a First In First Out (FIFO) in respect of the updating of the prevailing values of one or more of their static attributes. The pushing of a new data object onto the transaction log when fall automatically causes the deletion of the oldest data object in the transaction log as depicted in FIG. 2A showing a new DO₄₅ listing pushing the oldest DO₇ listing out of the transaction log. The one exception to this FIFO rule is that the pushing of a new data object onto the transaction log when full automatically causes a previous listing of the same data object to be deleted as depicted in FIG. 2B in respect of two DO₂₃ listings. This is because the transaction log needs only list a single data object once since the prevailing values of all the static attributes of a data object are uploaded together, and therefore additional listings would be superfluous.

Each EMS workstation manages a volume of data denoted CVD which is intended to mirror the NE workstation's master volume of data, and keeps a synchronization counter V_{C} which is synchronized with the master synchronization counter V_{S} in one of two different ways as follows: In the case an EMS workstation is the source of a command updating one or more static attributes in the master volume of data, then its synchronization counter V_{C} is synchronized with the master synchronization counter V_{S} when the prevailing values at the NE workstation have been successfully updated as a consequence of the command. Against this, in the case that an EMS workstation is not the source of a command updating one or more static attributes in the master volume of data, then its synchronization counter V_{C} is only synchronized with the master synchronization counter V_{S} after its volume of data mirrors the master volume of data. Or, in other words, after it has successfully uploaded the prevailing values of the static attributes updated as a consequence of a command from another EMS workstation.

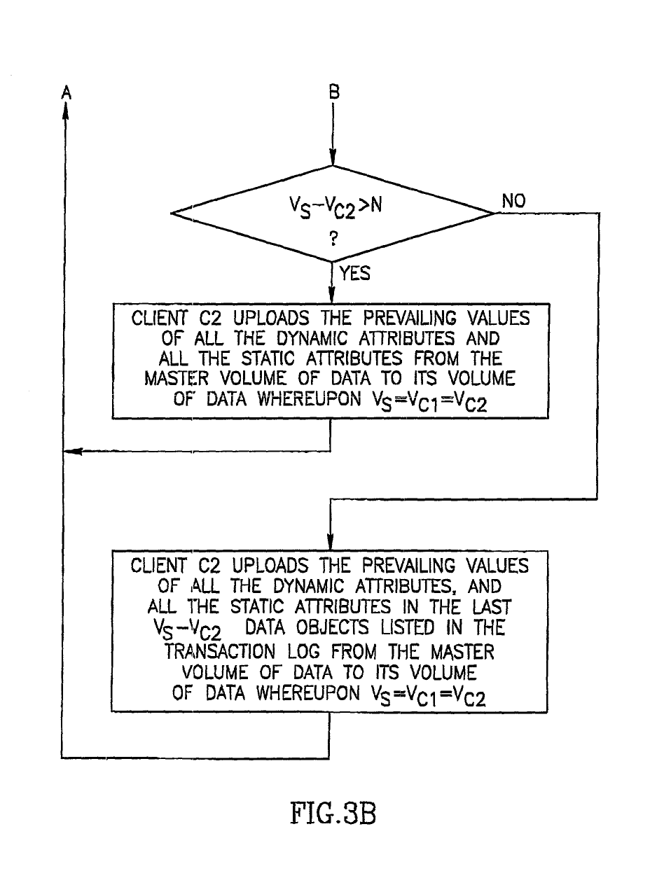

FIGS. 3A and 3B show that reconnection of the client V_{C2} to the server can lead to one of three possible uploads from the server's master volume of data to its volume of data as follows: First, a complete upload of the prevailing values of all the dynamic attributes and all the static attributes in the case that V_{S}−V_{C2}>N. Second, a partial upload of the prevailing values of all the dynamic attributes, and all the static attributes of the last V_{S}−V_{C} data objects listed in the transaction log in the case that V_{S}−V_{C2}≦N. And third, a partial upload of the prevailing values of all the dynamic attributes but none of the static attributes in the case that V_{S}=V_{C2}.

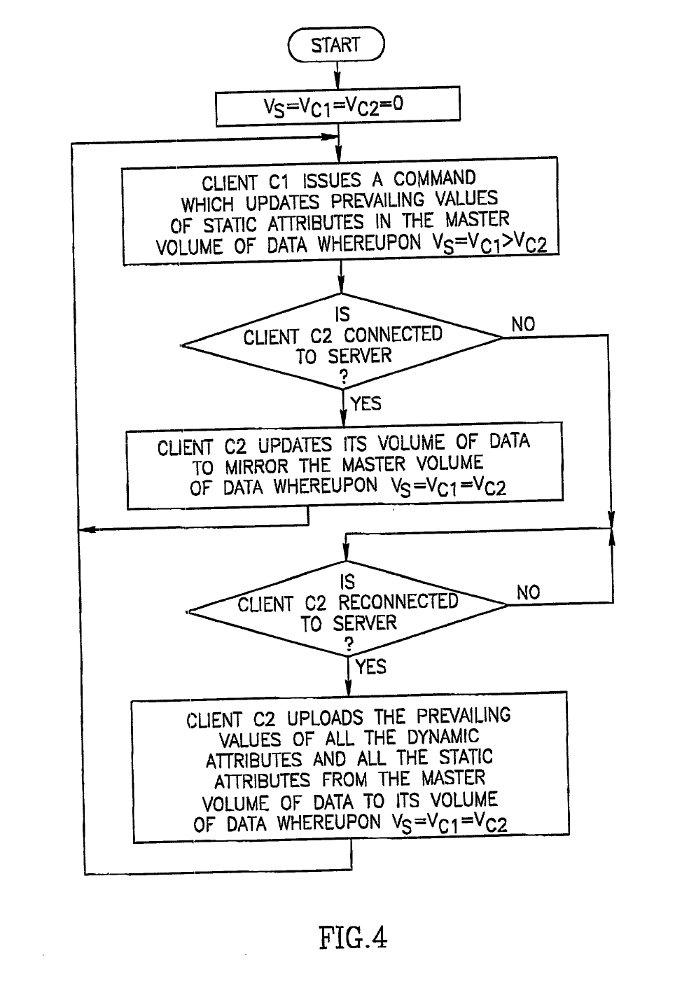

FIG. 4 shows that without the benefit of the transaction log, the data mirroring restoration method of the present invention degenerates to the complete upload in the case that V_{S}>V_{C2}, or a partial upload of the prevailing values of all the dynamic attributes but none of the static attributes in the case that V_{S}=V_{C2}. It should be noted that in such a degenerate version, the master synchronization counter V_{S} and the synchronization counters V_{C} may count attributes instead of data objects since the outcome of the decision as whether to upload the prevailing attributes of all the static attributes in the master volume of data or not will be the same in both cases.

While the invention has been described with respect to a limited number of embodiments, it will be appreciated that many variations, modifications, and other applications of the invention can be made within the scope of the appended claims.

1. For use in a distributed system including a server managing a master volume of data including a plurality of at least one static attribute and at least one dynamic attribute whose prevailing values in the master volume of data are respectively updated and not updated as a consequence of a command from a client, and at least two clients C1 and C2 each managing a volume of data intended to mirror the master volume of data, a method for data mirroring restoration at a client freshly reconnected to the server after a communication downtime period, the method comprising the step of:
(One) storing prevailing values of dynamic attributes of the master volume of data in temporary storage at the server;
(Two) storing prevailing values of static attributes of the master volume of data in persistent storage at the server;
(Three) providing the server with a master synchronization counter V_{S} incremented by the updating of the prevailing values of one or more static attributes in the master volume of data as a consequence of a command from a first client C1 of the at least two clients;
(Four) providing each client with a synchronization counter V_{C}, the synchronization counter V_{C2} of a second client C2 of the at least two clients only being synchronized with the master synchronization counter V_{S} on the successful uploading of the prevailing values of the static attributes updated in the master volume of data as a consequence of the command from the first client C1 whereby its volume of data mirrors the master volume of data; and
(Five) uploading from the master volume of data to the freshly reconnected client's volume of data, the prevailing values of all its dynamic attributes and, in the case that its synchronization counter V_{C2}<V_{S}, the prevailing values of at least all of its static attributes whose prevailing values were updated during the communication downtime period, otherwise in the case that V_{S}=V_{C2}, taking no data mirroring restoration action in respect of the static attributes.

2. The method according to claim 1 wherein step (e) includes the uploading the prevailing values of all the static attributes from the master volume of data to the freshly reconnected client's volume of data in the case that its synchronization counter V_{C2}<V_{S}.

3. The method according to claim 1 wherein step (c) includes providing the server with a transaction log for listing upto N data object identifiers of data objects containing at least one static attribute on a First In First Out (FIFO) basis in respect of the updating of the prevailing values of one or more of their static attributes, and step (e) includes the uploading from the master volume of data to the freshly reconnected client's volume of data the prevailing values of either all the static attributes in the case that V_{S}−V_{C2}>N, or all the static attributes of the last V_{S}−V_{C2} data objects listed in the transaction log in the case that V_{S}−V_{C2}≦N.

4. The method according to claim 3 further comprising the step of:
(f) when the transaction log is full, deleting an earlier listing of a data object therefrom, if it exists, on adding the same data object thereto, whereby the transaction log contains at most only a single listing of a data object, if at all.

5. A computer program adapted to carry out the method according to any one of claims 1 to 4.

6. A telecommunication network system adapted to carry out the method according to any one of claims 1 to 4.
